(19) United States
(12) Patent Application Publication
(10) Pub. No.: US 2015/0155070 A1
(43) Pub. Date: Jun. 4, 2015

(54) INSULATION FOR ELECTRICAL COMPONENTS

(71) Applicant: General Electric Company, Schenectady, NY (US)

(72) Inventors: Yang Cao, Niskayuna, NY (US); Christopher Michael Calebrese, Albany, NY (US); Stephen Francis Francese, Malta, NY (US); Xiaomei Fang, Niskayuna, NY (US); Christopher Anthony Kaminski, Niskayuna, NY (US); Yosang Yoon, Loudonville, NY (US); Wei Zhang, Ballston Lake, NY (US)

(73) Assignee: GENERAL ELECTRIC COMPANY, Schenectady, NY (US)

(21) Appl. No.: 14/096,430

(22) Filed: Dec. 4, 2013

(51) Int. Cl. H01B 3/30; H02K 3/34; H02K 3/30

(52) U.S. Cl. CPC H01B 3/30; H02K 3/30; H02K 3/34

(57) ABSTRACT

Embodiments of an insulation for electrical components are provided herein. In one embodiment an insulation for an electrical component may include a filler dispersed throughout a polymer matrix, the filler comprising a talc containing nanoclay and boron nitride. In one embodiment, an insulating tape for an electrical component may include a substrate and an insulation disposed atop the substrate, the insulation comprising a filler dispersed throughout a polymer matrix, the filler comprising a talc containing nanoclay and boron nitride. In one embodiment, a stator bar may include a conductive core and an insulating tape disposed atop one or more surfaces of the conductive core, the insulating tape comprising a substrate and an insulation disposed atop the substrate, the insulation comprising a filler dispersed throughout a polymer matrix, the filler comprising a talc containing nanoclay and boron nitride.

### BACKGROUND

The subject matter disclosed herein generally relates to insulation for electrical components.

Conventional insulations utilized in high power applications (e.g., electrical machines such as power generators, motors, or the like) are typically fabricated from mica containing materials. However, the inventors have observed that the conventionally utilized insulations suffer from inadequate heat transfer capabilities, dielectric strength and electrical (corona) discharge resistance, particularly when exposed to high voltage. As such, the conventional insulations are inefficient or unsuitable for applications where the insulation is subjected to high voltage stress or high thermal load.

Therefore, the inventors have provided an improved insulation for electrical components.

### SUMMARY

Embodiments of an insulation for electrical components are provided herein.

In one embodiment an insulation for an electrical component may include a filler dispersed throughout a polymer matrix, the filler comprising a talc containing nanoclay and boron nitride.

In one embodiment, an insulating tape for an electrical component may include a substrate and an insulation disposed atop the substrate, the insulation comprising a filler dispersed throughout a polymer matrix, the filler comprising a talc containing nanoclay and boron nitride.

In one embodiment, a stator bar may include a conductive core and an insulating tape disposed atop one or more surfaces of the conductive core, the insulating tape comprising a substrate and an insulation disposed atop the substrate, the insulation comprising a filler dispersed throughout a polymer matrix, the filler comprising a talc containing nanoclay and boron nitride.

The foregoing and other features of embodiments of the present invention will be further understood with reference to the drawings and detailed description.

### DESCRIPTION OF THE FIGURES

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of the invention and are therefore not to be considered limiting in scope, for the invention may admit to other equally effective embodiments.

FIG. 1 is a cross sectional view of an insulation for electrical components in accordance with some embodiments of the present invention.

FIG. 2 is a cross sectional view of an insulating tape comprising the insulation for electrical components shown in FIG. 1 in accordance with some embodiments of the present invention.

To facilitate understanding, identical reference numbers have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION OF PREFERRED EMBODIMENTS

Embodiments of an insulation for electrical components are disclosed herein. In at least one embodiment, the inventive insulation may advantageously provide an increased thermal conductivity, dielectric strength, electrical discharge resistance as compared to conventionally utilized insulations. In addition, in at least one embodiment, the inventive insulation may allow for the fabrication of an insulating tape that is more uniform as compared to insulating tapes that utilize conventionally utilized insulations. While not intending to be limiting in scope, the inventors have observed that the inventive insulation may be advantageously utilized in electrical machine applications, for example, such as power generators, motors, or the like.

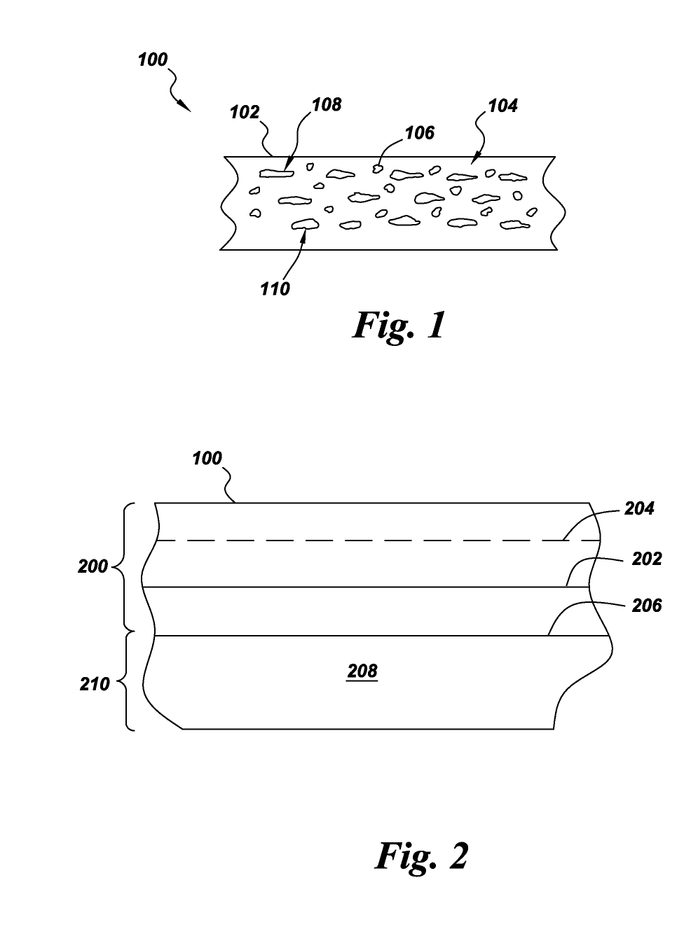

FIG. 1 is a cross sectional view of an insulation 100 for electrical components in accordance with some embodiments of the present invention. In one embodiment, the insulation 100 may generally comprise a filler 104 dispersed throughout a polymer matrix 102, wherein the filler 104 comprises a nanoclay 106. As used herein, the term “nanoclay” may generally include any clay having particles with an average dimension size of less than about 1000 nm. The particles may exist in the form of spheres, flakes, fibers, whiskers, combinations thereof, or the like and may have cross-sectional geometries that are circular, ellipsoidal, triangular, rectangular, polygonal, combinations thereof, or the like.

The inventors have observed that conventionally utilized insulations (e.g., insulations containing mica as a primary component) suffer from inadequate heat transfer capabilities and dielectric strength when exposed to high voltage. Moreover, in some applications, for example, such where the insulation is utilized to create an insulating tape, the inventors have observed that the conventional insulations (mica containing insulation) frequently suffer from wetting issues with other materials utilized to create the tape (e.g., epoxy), which may cause voids (e.g., microvoids) within the insulation, thereby reducing the effectiveness in discharge resistance of the insulation tape. Such deficiencies (e.g., inadequate heat transfer capabilities and dielectric strength, reduced effectiveness in discharge resistance, or the like) make the conventional insulations inefficient or unsuitable for high voltage applications. For example, in power generator applications, an output of the generator may be limited by an inability to efficiently transfer heat between components of the generator to facilitate efficient cooling of a stator and rotor (e.g., heat transfer from a copper core of a stator bar to one or more gas ducts disposed proximate the stator bar). The inventors have observed that the inadequate heat transfer capabilities of conventional insulations may limit such efficient transfer of heat, thereby limiting the power output and/or making the generator less efficient.

As such, in one embodiment, the nanoclay 106 is a talc containing nanoclay. As used herein, the term “talc” may include any hydrous magnesium silicate composition, for example, generally comprising the chemical formula H₂Mg₃(SiO₃)₄ or Mg₃Si₄O₁₀(OH)₂. Providing talc improves heat transfer capabilities, thereby overcoming the aforementioned limitations of the conventionally utilized insulations. For example, the talc may provide an intrinsically higher thermal conductivity in both through thickness and along thickness directions of the insulation 100, thus producing an insulation having a higher overall thermal conductivity, as compared to conventional mica-based insulations. For example, in one embodiment, the inventors have observed a thermal conductivity of the insulation 100 of about 0.6 to 1.03 W/m-k, such as about 0.936 W/m-k at 155 degrees Celsius, as compared to a thermal conductivity of a conventional insulation of about 0.3 W/m-k at 155 degrees Celsius.

In addition, the talc may provide an increased dielectric strength and electrical (corona) discharge resistance of the insulation 100 as compared to the conventional mica-based insulations. For example, in one embodiment, the inventors have observed a dielectric strength of the insulation 100 of about 26 to about 44 KV/mm, as compared to a dielectric strength of a conventional insulation of about 25 KV/mm. In another example, in one embodiment, the inventors have observed a breakdown strength of the insulation 100 of greater than about 750 V/M, for example, such as up to about 1400 V/M, as compared to a breakdown strength of a conventional insulation of less than about 750 V/M. In another example, in one embodiment, the inventors have observed a dielectric dissipation factor of the insulation 100 of less than about 3%, or in one embodiment, less than about 2.5% at 155 degrees Celsius, as compared to a dielectric dissipation factor of a conventional insulation of about 3% or greater at 155 degrees Celsius. Without intending to be bound by theory, the inventors believe that the more refined layer structures of talc as compared to mica may provide the improved aforementioned electrical properties (e.g., increase in dielectric strength, electrical discharge resistance, or the like).

In one embodiment, the filler 104 may further comprise one or more additional components (shown at 108 and 110) suitable to provide one or more desired properties to the insulation 100 (e.g., thermal conductivity, dielectric strength, electrical discharge resistance, or the like). For example, in one embodiment, the filler 104 may further comprise boron nitride (BN). When present, the boron nitride may supplement the talc to further increase the thermal conductivity of the insulation 100 while reducing an overall loading of the talc within the polymer matrix 102 for ease of processing. In addition, in another example, in one embodiment, the filler 104 may further comprise an oxide, for example, zinc oxide. When present, the zinc oxide may enable synergistic electrical discharge resistance, thereby increasing the electrical discharge resistance of the insulation 100. Without being bound by theory, the inventors believe that the zinc oxide may facilitate a sputtering effect during electrical discharge that will redistribute the nanoclay 106 and the additional components 108, 110 within the polymer matrix 102, thereby forming a less resistive surface, thereby enabling charge/energy dissipation anistropically.

The polymer matrix 102 may include any polymer suitable to provide a desired mechanical strength to the insulation 100 that is process compatible with a desired application. For example, in one embodiment, the polymer may be at least one of rubbers (silicone rubber, ethylene propylene rubber, or the like), polyurethanes, epoxies, phenolics, silicones, polyacrylics, polycarbonates polystyrenes, polyesters, polyamides, polyamideimides, polyarylates, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polybutadienes, polyisoprenes, combinations thereof, or the like.

The insulation 100 may comprise any amounts of the polymer matrix 102 and the components of the filler 104 (e.g., nanoclay, boron nitride, zinc oxide, or the like) suitable to provide one or more desired properties to the insulation 100 (e.g., thermal conductivity, dielectric strength, electrical discharge resistance, or the like). For example, in one embodiment, the insulation 100 may comprise the polymer matrix 102 in an amount of up to about 75%, or in one embodiment, about 50%, or about 62.5% of the total weight of the insulation 100. In another example, in one embodiment, the insulation 100 may comprise the nanoclay 106 in an amount of about 30% to about 45%, or in one embodiment, about 35% of the total weight of the insulation 100. In another example, in one embodiment, the insulation 100 may comprise zinc oxide in an amount of less than about 5% of the total weight of the insulation 100. In another example, in one embodiment, the insulation 100 may comprise boron nitride in an amount of less than about 20% of the total weight of the insulation 100.

The filler 104 may be dispersed within the polymer matrix 102 via any method suitable to provide a desired dispersion of the filler 104 within the polymer matrix 102. For example, in one embodiment, a high shear mixing process may be utilized to disperse pre-dried nanoclay into a polymer. The shear may be imparted in a melt blending process or it may be imparted via other means such as the application of ultrasonic energy to the mixture. Suitable examples of melt blending equipment are extruders such as single screw extruders, twin screw extruders, or the like; buss kneaders, roll mills, paint mills, helicones, combinations thereof, or the like. In one embodiment, the polymer and nanoclay mixture may then be cast and/or applied to a substrate (e.g., to form an insulating tape as described below) and subsequently thermally cured.

The inventors have observed that in some high voltage applications, such as power generators, a substantial amount of space (e.g., side clearance) may be needed between certain components to accommodate for a thickness, and variations of the thickness, of conventional insulations utilized in the power generator. As such, referring to FIG. 2, in one embodiment, the insulation 100 may be disposed on a substrate 202 to form an insulating tape 200. The insulating tape 200 may be utilized in any application that would benefit from the advantages of the insulation 100 as described herein. For example, in one embodiment, the insulating tape 200 may be disposed atop a component of, for example, an electrical machine such as power generators, motors, or the like. For example, in one embodiment, the insulating tape 200 may be disposed atop one or more surfaces 206 of a stator bar 210 core (conductive core) 208.

The inventors have observed that, because of the comparatively improved heat transfer and electrical properties of the insulation 100, as discussed above, the insulating tape 200 may be more uniform and having tighter tolerances as compared to conventional insulating tapes utilizing conventional insulation (e.g., mica based insulations). The uniformity and tighter tolerances of the insulating tape 200 allows for a reduction of side clearances needed between components of the generator, thereby further enhancing heat transfer capability between the components and, thus increasing output and making the generator more efficient and cost effective.

The substrate 202 may be any type of substrate suitable to provide a sufficient mechanical strength to facilitate application of the insulating tape to an electrical component (e.g., a stator bar core). For example, in one embodiment, the substrate 202 may be a polymer containing backing, for example such as a fiberglass tape.

In one embodiment, the insulating tape 200 may include a layer 204 comprising mica disposed between the substrate 202 and the insulation 100. Examples of mica that may be used are anandite, annite, biotite, bityte, boromuscovite, celadonite, chernikhite, clintonite, ephesite, ferri-annite, glauconite, hendricksite, kinoshitalite, lepidolite, masutomilite, muscovite, nanpingite, paragonite, phlogopite, polylithionite, preiswerkite, roscoelite, siderophillite, sodiumphlogopite, taeniolite, vermiculite, wonesite, and zinnwaldite. Exemplary forms of mica are phlogopite (KMg₃AlSi₃O₁₀(OH)₂) or muscovite (K₂Al₄[Si₆Al₂O₂₀](OH,F)₄).

The substrate 202, insulation 100 and layer 204 (when present) may each have any thickness suitable to provide one or more desired thermal or electrical properties (e.g., the properties described above) to accommodate for a particular application. For example, in one embodiment, the substrate 202 may have a thickness of about 0.5 to about 4 mils, or in one embodiment, about 2 mils. In another example, in one embodiment, the insulation 100 may have a thickness of about 2 to about 8, or in one embodiment, about 5 mils. In another example, in one embodiment, the layer 204 may have a thickness of up to about 2 mils.

Thus, embodiments of an insulation for electrical components have been provided herein. In at least one embodiment, the inventive insulation may advantageously provide an increased thermal conductivity, dielectric strength, electrical discharge resistance as compared to conventionally utilized insulations. In addition, in at least one embodiment, the inventive insulation may allow for the fabrication of an insulating tape that is thinner and more uniform as compared to insulating tapes that utilize conventionally utilized insulations.

Ranges disclosed herein are inclusive and combinable (e.g., ranges of “about 30% to about 45%”, is inclusive of the endpoints and all intermediate values of the ranges of “about 30% to about 45%” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced items. The modifier “about” used in connection with a quantity is inclusive of the stated value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. An insulation for an electrical component, comprising:
a filler dispersed throughout a polymer matrix, the filler comprising a talc containing nanoclay and boron nitride.

2. The insulation of claim 1, wherein the insulation comprises the polymer matrix in an amount of up to about 75% of a total weight of the insulation.

3. The insulation of claim 1, wherein the insulation comprises the talc containing nanoclay in an amount of about 30% to about 45% of a total weight of the insulation.

4. The insulation of claim 1, wherein the insulation comprises the boron nitride in an amount of less than about 20% of a total weight of the insulation.

5. The insulation of claim 1, wherein the filler further comprises zinc oxide.

6. The insulation of claim 5, wherein the insulation comprises the zinc oxide in an amount of less than about 5% of the total weight of the insulation.

7. An insulating tape for an electrical component, comprising:
a substrate; and
an insulation disposed atop the substrate, the insulation comprising a filler dispersed throughout a polymer matrix, the filler comprising a talc containing nanoclay and boron nitride.

8. The insulating tape of claim 7, further comprising a layer comprising mica disposed between the fiberglass substrate and the insulation.

9. The insulating tape of claim 8, wherein the layer has a thickness of up to about 2 mils.

10. The insulating tape of claim 7, wherein the substrate has a thickness of about 0.5 to about 4 mils.

11. The insulating tape of claim 7, wherein the insulation has a thickness of about 2 to about 8 mils.

12. The insulating tape of claim 7, wherein the insulation comprises the polymer matrix in an amount of up to about 75% of a total weight of the insulation.

13. The insulating tape of claim 7, wherein the insulation comprises the talc containing nanoclay in an amount of about 30% to about 45% of a total weight of the insulation.

14. The insulating tape of claim 7, wherein the insulation comprises the boron nitride in an amount of less than about 20% of a total weight of the insulation.

15. The insulating tape of claim 7, wherein the filler further comprises zinc oxide.

16. The insulating tape of claim 15, wherein the insulation comprises the zinc oxide in an amount of less than about 5% of the total weight of the insulation.

17. A stator bar, comprising:
a conductive core; and
an insulating tape disposed atop one or more surfaces of the conductive core, the insulating tape comprising a substrate and an insulation disposed atop the substrate, the insulation comprising a filler dispersed throughout a polymer matrix, the filler comprising a talc containing nanoclay and boron nitride.

18. The stator bar of claim 17, wherein the insulating tape further comprises a layer comprising mica disposed between the fiberglass substrate and the insulation.

19. The stator bar of claim 17, wherein the filler further comprises zinc oxide.

20. The insulation of claim 17, wherein the insulation comprises the polymer matrix in an amount of up to about 75% of a total weight of the insulation, the talc containing nanoclay in an amount of about 30% to about 45% of a total weight of the insulation and the boron nitride in an amount of less than about 20% of a total weight of the insulation.
